(19) United States
(12) Patent Application Publication
(10) Pub. No.: US 2007/0067317 A1
(43) Pub. Date: Mar. 22, 2007

(54) Navigating through websites and like information sources

(76) Inventor: David Watt Stevenson, West Lothian (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/554,031

(22) PCT Filed: Apr. 23, 2004
(86) PCT No.: PCT/GB04/01749

§ 371 Date: Aug. 16, 2006

(30) Foreign Application Priority Data
Apr. 23, 2003 (GB) 0309174.1

(51) Int. Cl. G06F 7/00

(52) U.S. Cl. 707/100

(57) ABSTRACT

An interactive/electronic guide for allowing navigation around a group of electronic documents, such as on internet or in an intranet site or such like, the guide being operable automatically to present a plurality of topic identifiers together with an indication of the importance of the topics identified within a site. Each topic is user selectable. Selection of a given topic provides access to information on that topic. Preferably, the guide also provides information about multiple sites that are potentially related by content as well as an indication of a degree of similarity in content between such multiple sites.

The present invention relates to an improved system and method for locating and navigating to information contained within groups of information on the worldwide web, such as websites, or similar information sources. The present invention also relates to a system and method for generating an interactive guide, which allows easy navigation to such information.

Senior executives and researchers often have difficulty in obtaining accurate information about what is going on at a detailed level in corporate organisations. Increasingly however, corporate web sites contain a wealth of information, for example, about a company's products, staff and organisation. If easy access to this information were readily available, it could provide a valuable resource. At present, however, it can be difficult to locate relevant websites and find information due to the inefficiency of current web site location and browsing techniques, and the difficulty of identifying important topics amongst the mass of information available.

Various searching and browsing techniques are available at present for locating and navigating through web sites. The first of these is the conventional search engine. This identifies web pages that contain specific words or phrases entered in the search engine box. This technique relies on the searcher knowing the exact word or phrase that is used on a web site to identify a specific topic. Whilst this method of searching can be effective for hard information such as product names, it is less effective when searching for more abstract concepts and where different words and phrases can be used to describe the same or related information. For example, a search on the word “teacher” on a search engine or web site can be effective if all the required information is on a page that contains the word “teacher”. However, if there is related information on another page that does not include the word “teacher”, for example topics such as: “education”, “school”, “children”, and “classroom”, then this will not be located by a search engine search on the key word “teacher” alone. A further disadvantage of this approach when looking for specific types of business (e.g. when locating potential merger and acquisition targets, marketing and sales prospects or business partners) is that it locates individual web pages, which may reflect only a tiny proportion of the activities of a given company. There can be tens of thousands of web pages on a given corporate website and hence generally a single page cannot reflect the activities of a company as a whole, making the process of identifying companies based on the range of their activities difficult.

To assist the user navigate within a web-site, a conventional approach is to provide a site map or links page. These typically provide a long list of subject topics and sub-topics, with links to individual pages that contain these topics in websites. Site maps are generally manually generated and at a relatively high level. Hence, they often lack significant detail and can be relatively flat in organisation and structure. This means that obtaining information can be quite difficult since it not usually possible to “drill-down” beyond one level of information, requiring the user to return to the site map each time they wish to browse information about a different topic.

Another conventional technique for navigating round web sites is manual browsing. The web typically contains millions of pages that are interlinked by multiple possible paths between each page. Selecting links contained within a particular page allows a user to navigate to the next linked page that contains information identified by the link text or graphic. However, it can be difficult when browsing manually to ensure that pages containing relevant information have not been missed and that a page has not been visited previously. In addition, textual links used on a typical web site often contain insufficient words due to space restrictions to adequately describe the multitude of topics that can be reached via the link. A further disadvantage of manual browsing is that the user often skim-reads each web page, which inevitably leads to more perceptive emphasis on header text and other items that are highlighted visually on the page. This may skew the effectiveness of the user in identifying key information when skimming a page, if the required key words are not contained in the emphasised text.

An object of the invention is to provide an improved system and method for the location of groups of information on the world-wide web or other such like information source. Such groups typically will be contained within websites identified by a Uniform Resource Locator (URL) such as www.google.com or www.uspto.gov.

Another object of the invention is to provide an improved method for navigating between and within groups of information on the world-wide web or other information store. Such groups typically will be contained within the confines of a single website, or within websites that are related by content.

Various aspects of the present invention are defined in the accompanying independent claims. Some preferred features are defined in the dependent claims.

According to one aspect of the invention, there is provided a method for profiling a group or collection of text based electronic documents, the method comprising: analysing every document in the group to identify key topics; allocating a measure of importance to identified key topics, and using that measure to generate a topic profile that includes a plurality of topic identifiers and an indication of the importance of the topics identified to the group as a whole.

Preferably, the group of electronic documents comprises pages of a web site. In this case, the method may further involve downloading each page of the site in order to do the step of analysing.

The step of analysing the documents may involve searching for specific words. Additionally or alternatively, the step of analysing involves searching and eliminating topics that are not related to important key words. Additionally or alternatively, the step of analysing may involve determining a list of words related to each of a plurality of key topics identified in the group; determining whether each key topic appears in the list of related words for any of the other key topics in the group and discarding any of the key topics where the key topic does not appear in the list of related words for any other of the key topics.

According to another aspect of the invention, there is provided a system for profiling a group or collection of text based electronic documents, the system comprising: means for analysing every document in the group to identify key topics; means for allocating a measure of importance to identified key topics, and means for using that measure to generate a topic profile that includes a plurality of topic identifiers and a measure or indication of the importance of the topics identified to the group as a whole.

According to yet another aspect of the invention, there is provided a method of navigating within a group of electronic documents, such as a subset of the world-wide web, for example an internet or intranet site or such like, the method comprising: automatically presenting on a screen or display a plurality of topic identifiers, together with an indication of the relative importance of the topics identified to the group as a whole, each topic being user selectable; receiving a user selection of a given topic and providing access to information on the selected topic in response to the user selection.

By automatically presenting the topic identifiers together with their relative importance, without the need for a user to initiate a keyword search, there is provided a simple but effective technique for allowing a user to navigate easily towards information that is of interest.

According to still another aspect of the invention, there is provided an interactive/electronic guide for allowing navigation around a group of electronic documents, such as an internet or intranet site or such like, the guide being operable automatically to present a plurality of topic identifiers together with an indication of the importance of the topics identified, each topic being user selectable, wherein selection of a given topic provides access to information on that selected topic.

According to a still further aspect of the invention, there is provided a method for locating groups of information on the world wide web or in other information stores, the method comprising: identifying a plurality of candidate groups of information; deriving a profile of content for each candidate group; comparing the profile of a first candidate group with each and every other candidate group in said plurality of candidate groups and identifying and measuring any difference or differences in topic profiles between the first and other candidate groups.

By comparing profiles of content of a plurality of different web sites, there is provided a simple mechanism for identifying sites that have similar or related content, or identifying sites that match any desired profile of content.

According to a yet still further aspect of the invention, there is provided a method for navigating between and within groups of information on the world-wide web or other information store comprising: presenting on a screen or display a plurality of group identifiers, together with an indication of the similarity of the group identified relative to a desired profile of content, each group being user selectable; receiving a user selection of a given group identifier, and providing access to information on the selected group in response to the user selection.

According to yet another aspect of the invention, there is provided an interactive/electronic guide for locating groups of documents, such as websites on the world-wide web or such like, the guide being operable to present a plurality of group identifiers, together with an indication of the similarity of each group to a target profile of content, each group identifier being user selectable, wherein selection of a group identifier provides access to information on that selected group.

Various aspects of the invention will now be described by way of example only and with reference to the accompanying drawings, of which

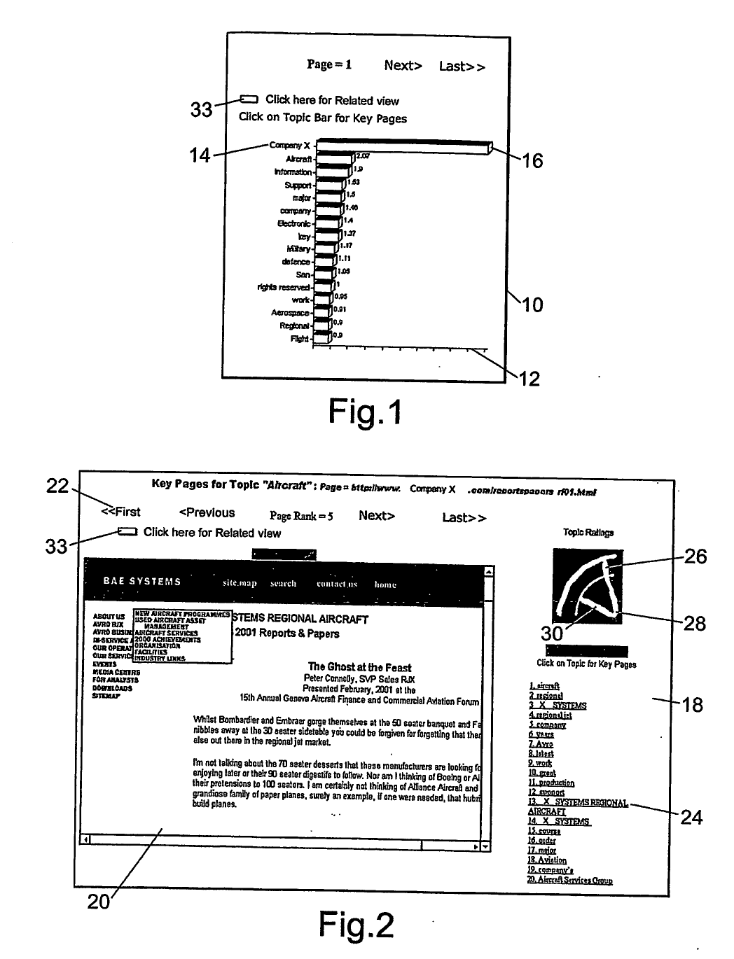

FIG. 1 is an example view of a Main View of an electronic guide for locating and navigating to and within web sites that has a list of key site topics;

FIG. 2 is an example view of a Subsequent View that is presented to a user when a key topic is selected from the list of FIG. 1;

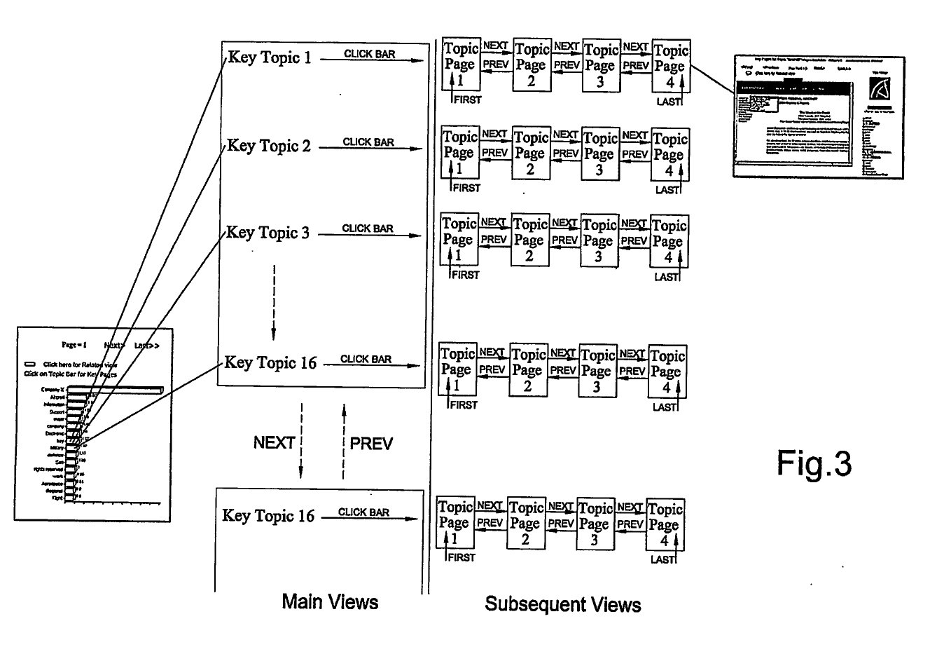

FIG. 3 is a diagram of the hierarchy of links between the pages shown in FIGS. 1 and 2;

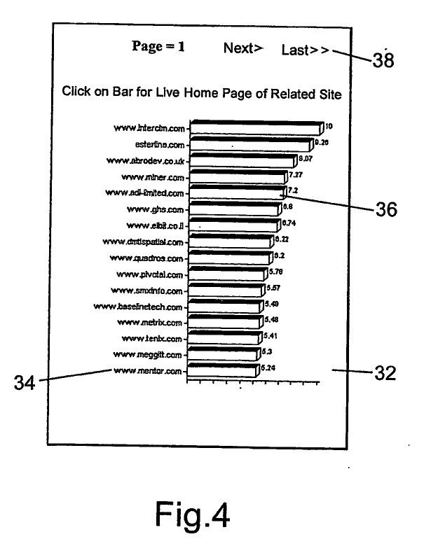

FIG. 4 is an example view of a Related View of an electronic guide for locating and navigating to web sites that are related to a target topic profile such as that shown in FIG. 1;

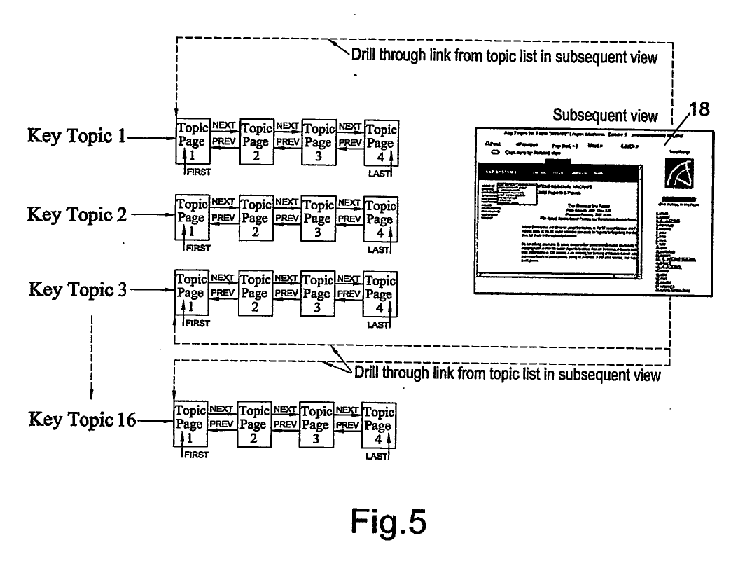

FIG. 5 illustrates the infinite drill-through capability of the guide;

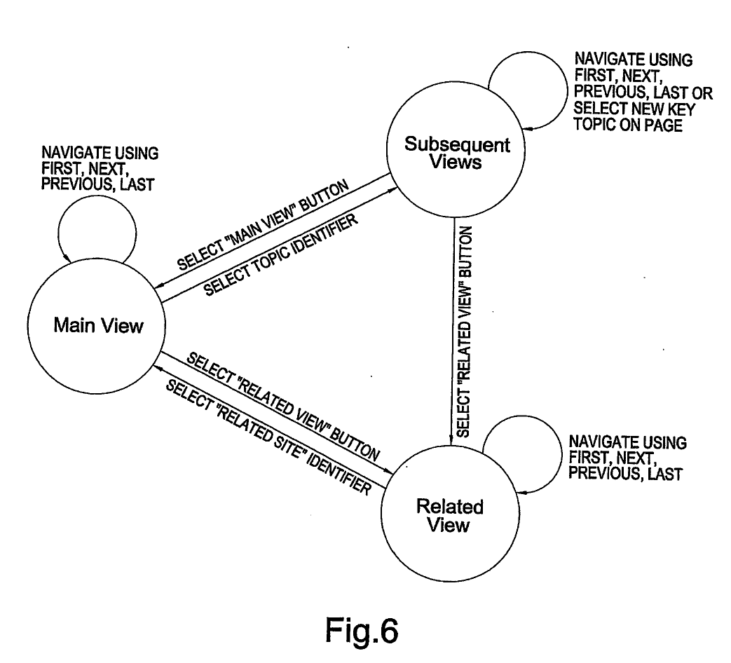

FIG. 6 illustrates various ways in which a user can navigate through the guide of FIGS. 1 to 3;

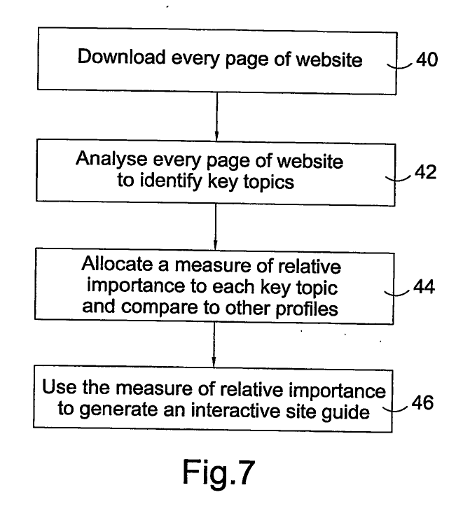

FIG. 7 is a high level flow diagram of the steps for creating the guide of FIGS. 1 to 3;

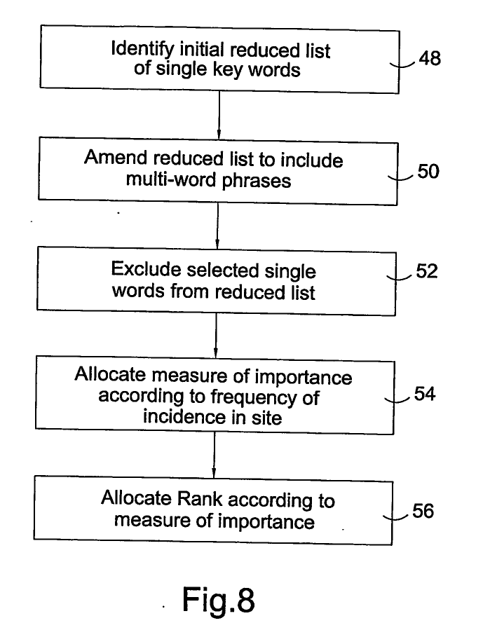

FIG. 8 is more detailed flow diagram of the steps taken to create the guide of FIGS. 1 to 3;

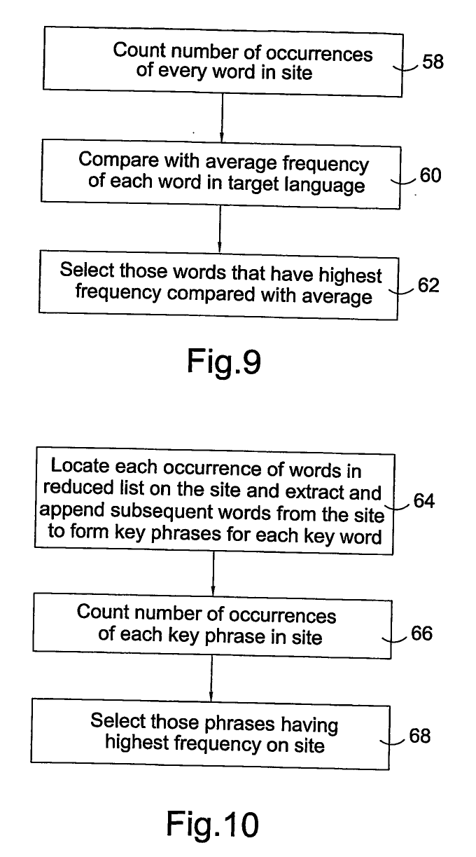

FIG. 9 is a flow diagram of the steps for devising an initial list of key topics;

FIG. 10 is a flow diagram of various steps for reducing the initial key topic list derived from carrying out the steps of FIG. 9;

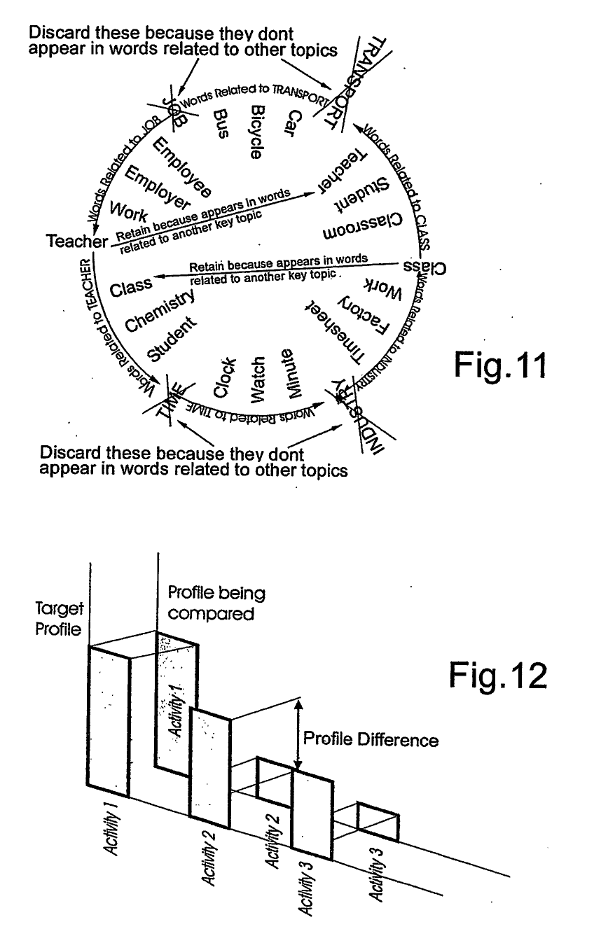

FIG. 11 illustrates the use of related words to discard topics, which are not related to the subset of information as a whole;

FIG. 12 is a diagram that illustrates a process for comparing topic profiles between two groups of information;

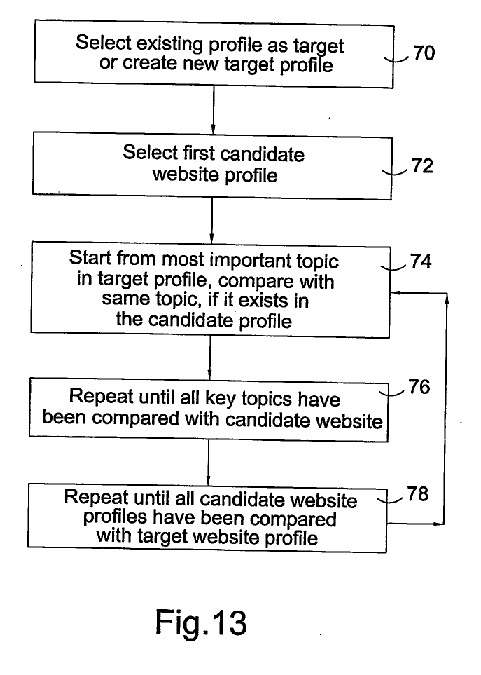

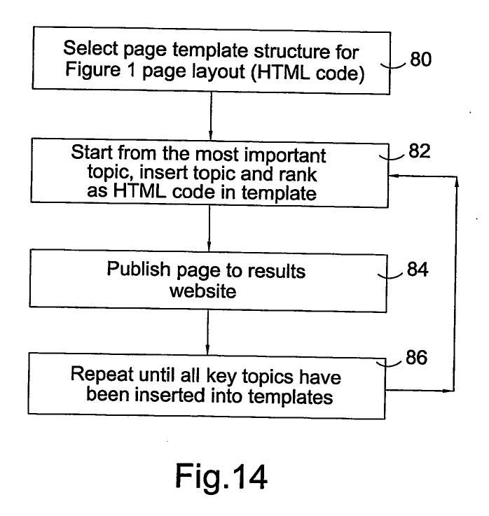

FIG. 13 is a flow diagram of the steps required to compare profiles of two websites;

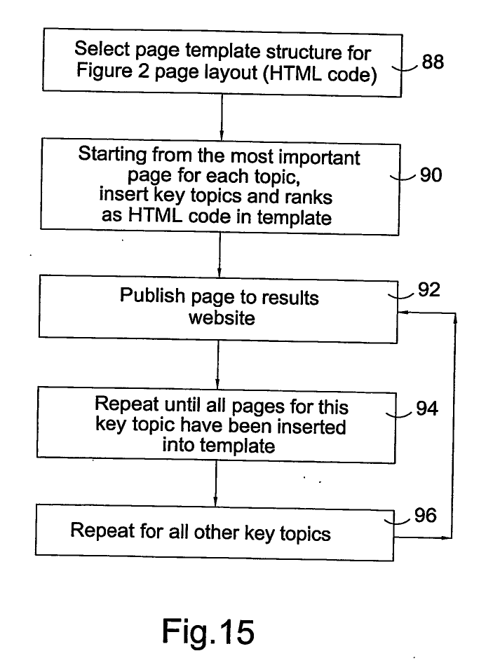

FIG. 14 is a flow diagram of the steps for creating the Main View page of FIG. 1 using key topic information;

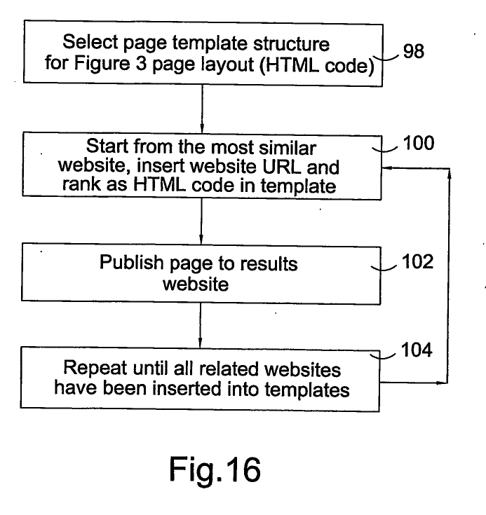

FIG. 15 is a flow diagram of the steps for creating the Subsequent View page of FIG. 2, and

FIG. 16 is a flow diagram of the steps for creating the Related View page of FIG. 3.

FIG. 1 shows a Main View page 10 of an electronic guide 12 for a web site, in which user selectable key topic identifiers 14 are automatically presented, without the user having to enter a topic or keyword to initiate a search. In practice, the guide 12 can be presented to a viewer prior to pages from the web site being downloaded from a remote server. Mechanisms for creating and downloading web sites are, of course, very well known and so will not be described herein in detail. Typically, the key topic list extends over several site pages. To accommodate navigation between these pages, there is provided a set navigation buttons including “first”, “next”, “previous” and “last” buttons. Clicking any one of these buttons this causes the desired set of key topics to be listed. Clicking through successive sets of key topics takes the user from the most important set to least important set of key topics in consecutive order.

The key topic identifiers 14 of the Main View 10 shown in FIG. 1 are provided in a pre-determined order, with the most important topics being presented first. This means that a searcher does not need to know in advance the actual text for a topic that the authors have used in a web site, but rather can select from a list of possible topics of most interest to them. So, for example, a web site for teachers might identify all the topics “teacher”, “education”, “school”, “children”, and “classroom” as being the most important topics in the site, and display these at the top of the list of important topics, allowing the user to click on any of these to navigate to relevant content. Given that a visitor to a web site for, or about, teachers is likely to be interested in all these topics, this is a key benefit over a conventional search engine, which would return content about the single topic “teacher” only when entered in a search box. Likewise, and as shown in FIG. 1, for a web site for a company, such as company X, that makes aeronautical engineering products, the topics could be “electronic”, “aircraft”, “company” etc.

As well as presenting topics so that the most important are first in the list, the Main View page of FIG. 1 provides a visual topic profile that gives a clear visual indication of the relative importance of various topics. In particular, FIG. 1 shows a list of key topics, together with a graphical indication 16 of the importance of these topics, with the most important topics on the site being presented at the top. More specifically, for each topic in the guide of FIG. 1, there is provided a bar 16 that illustrates the importance of that topic to the site. This allows important content to be highlighted even if it is hidden deep in the web site rather than clearly displayed on the home page of the site. The key topics list can show each of the key topics as a single or multi-word phrase.

Each topic identifier 14 or bar 16 in the key topic profile may be selected. Clicking on the identifier and/or bar causes a Subsequent View 18, containing another topic list, to be presented. In this Subsequent View 18, the information may be related specifically to a page that contains content relevant to the selected key topic in the Main View 10.

An example of a Subsequent View 18 that is presented when one of the topics 14 or bars 16 of FIG. 1 is selected is shown in FIG. 2. This has a live web page 20 in a frame. In this example, the guide is adapted to allow the user to click to the live web page 20 itself; to other Subsequent View pages that are important to the selected topic using “first”, “next”, “previous” and “last” buttons, or to still other Subsequent View pages that contain information related to the other key topics 24 listed on this Subsequent View page. These other key topics 24 are those which are important to this page only, rather than important to the website as whole and are listed in descending order of importance to the page. This allows easy access to related topics because inter-related topics are often clustered on the same page and so clicking on any of these related key topics takes the user straight to the top page for that key topic, making for easy browsing. For example, the Subsequent View for a page about “Doctor Smith's chemistry class” may list the following key topics relevant to this page only: Doctor Smith; chemistry; Bunsen burner; element; chemistry department, and allow one-click access to top Subsequent View pages for each of these key topics on the page. Such click-through capabilities allow easy access to key content via a drill-down/drill-through capability, which eliminates the need to return to a site map page or Main View when wishing to navigate to another important topic within a site.

In the Subsequent View 18 of FIG. 2 topic ratings are also provided. These show how highly this topic rates relative to other topics, both on this page and on the site as a whole. In particular, an indicator 26 having two scales and two pointers is provided. The pointer 28 of the first scale indicates the importance of the selected key topic to the overall site. The pointer 30 of the second scale indicates the importance of a selected topic in the Subsequent View list relative to other topics in that Subsequent View list. Clicking through successive Subsequent Views of key pages for a selected topic using navigation buttons such as “next” takes the user from the most important to least important key pages for this topic in consecutive order. FIG. 3 shows how the pages of FIGS. 1 and 2 are linked.

As well as providing a mechanism for navigating a web site, the guide of FIG. 1 can be adapted to provide a means for linking a user to webs sites that have similar topic profiles, thereby to provide an inter-site access mechanism as well as intra-site access. To this end, the guide includes one or more Related View pages 32. These can be accessed by clicking on a “Related View” link 33, which is presented in each of the Main and Subsequent Views. FIG. 4 shows an example of a Related View page 32 for navigating to such related web sites, in which user selectable website identifiers 34 are presented. The related website identifiers 34 of the Related View 32 shown in FIG. 4 are provided in a pre-determined order, with the websites having a topic profile that is most similar to the target topic profile being presented first. Preferably, the Related View page 32 provides a visual profile that gives a clear visual indication of the similarity of websites to the target profile. In particular, FIG. 4 shows a list of websites, together with a graphical indication 36 of the similarity of the websites to the target profile, with the most similar websites being presented at the start. More specifically, for each website in the page of FIG. 4, there is provided a bar 36 that illustrates the similarity of that website to the target profile. This means that a searcher can easily select from a list of related websites. This allows the user to locate similar websites, which can be useful, for example, when identifying merger and acquisition targets, when the target profile of both potential acquirer and acquire may be similar.

Typically, the website list of FIG. 4 extends over several site pages. As before, to accommodate this, generally, there is provided a set of navigation buttons 38 including “first”, “next”, “previous” and “last” buttons. Clicking these allows a user to cause the desired set of websites to be listed. Clicking through successive sets of websites takes the user from the most closely related set to least closely related set of websites in consecutive order. In addition, each website identifier 34 or bar 36 in the website list may be selected. Preferably, the Related View page is adapted so that clicking on either of the identifier 34 or bar 36 causes more information about the overlaps and differences between the respective topic profiles to be presented.

The guide of FIG. 1 to 3 has a linked nature that provides a drill-down capability of unlimited depth, as shown in FIG. 5. This is not possible in a conventional site map. This drill-down capability relies on the fact that inter-related topics are often clustered around each other in text on a page. So, for example, related topics such as “education”, “school”, “children”, and “classroom” are often clustered on a web page around the word “teacher”. This allows a searcher who has clicked-through from the Main View 10 to the first Subsequent View 18 for the topic “teacher” to review all the other key topics on that page, including those closely related, and then click-through to the first Subsequent View for any of the other key topics on the page. This allows an infinite drill-through the site, clicking between topics and pages without returning to the Main View or a site map, thereby providing a significantly improved technique for navigating around the site. In contrast, a conventional site map would require the user to click back to the site map to click-through to pages for another topic on the site. In addition to this, by providing the Related View pages, the user can advantageously conduct an inter-site search and navigation.

FIG. 6 shows the different navigation routes that can be used when navigating between the navigation pages of FIGS. 1, 2 and 3. From the initial Main View, preferably starting with the most important topics, the buttons “First”, “Next”, “Previous” and “Last” can be used to navigate through the list of key topics in the Main View. Selecting a Topic Identifier in the Main View causes a Subsequent View page to be presented, and further Subsequent View pages can be navigated using “First”, “Next”, “Previous” and “Last” buttons to navigate, preferably from most important to least important key pages for the topic selected previously in the Main View. Selecting the “Main View” button in the Subsequent View returns to the Main View for the site. Selecting the “Related View” button 33 in any Subsequent or Main View navigates to the Related View page, from where the “First”, “Next”, “Previous” and “Last” buttons can be used to navigate the list of related sites, preferably starting with the most similar site. Selecting any related website identifier (generally a URL) in the Related View will navigate to the Main View for the related site, while selecting the “Related View” button in the Main View will navigate to the Related View of similar sites, preferably starting with the most similar.

FIG. 7 shows the steps for constructing the guides of FIGS. 1, 2 and 3. In practice, these steps would be carried out by guide creation/analysis software running in a suitable processor (not shown). The first step is to fully and comprehensively analyse the web site(s) of interest to identify key subject matter topics. To do this, some or all of the accessible pages from each target web site is firstly 40 downloaded from the server or computer based processor on which it is provided to the processor that includes the analysis software. Each page is then analysed 42 to identify key topics. The importance of each key topic is then determined 44, and profiles of topics are compared. Finally, this information is used to generate the guide(s) 46. More specifically, each page of the site is processed, once only, to extract important topics. This ensures that the key topics on each page are identified and logged only once on each page. Mutually exclusive, mutually exhaustive processing is applied to all accessible content on the web site. The process does not distinguish between different content formats. Hence, text that is formatted as a heading is processed the same as body text to eliminate the perceptive bias, which can occur when a user skim-reads a page.

In order to identify key topics, the basic technique used is to process every word on the site, and successively reduce the number of potential topics from the entire word content down to a manageable level, thereby to highlight key topics. FIG. 8 shows the steps that are taken in an example method for identifying key topics. This involves identifying an initial reduced list of single key words 48; amending the reduced list to include multi-word phrases 50; excluding single words, other than some selected single words from the reduced list 52; allocating a measure of importance according to frequency of incidence of the topic in the site 54, and allocating a rank according to the measure of importance 56. FIG. 9 shows in more detail steps for identifying the initial reduced list. This involves counting the number of occurrences of every word in the site 58; comparing these numbers with an average frequency for each word in either the specific language of the website as a whole e.g. English, or a subset of this language 60 and selecting those words that have an above average frequency of occurrence 62.

Once the initial reduced list is determined, several techniques are employed to reduce the number of key topics that are included. This is necessary because conventional search engine techniques have limited accuracy and relevance, often including phrases in the reduced list that are not really key to the specific content of the web site. One technique for reducing the key topics is to search for and include multi-word phrases. This is done by locating each occurrence of a word in the initial reduced list on the site and extracting and appending subsequent words from the site to form key phrases for each key word 64, as illustrated in FIG. 10. The occurrence of each of these key phrases is counted 66, and those phrases that have the highest frequency are selected and included in the list 68.

After the multi-word phrases are analysed and added to the list, some of the single word topics on the list are excluded. This is because, in general, single word topics convey less-specific information to the user than multi-word topics, and hence may be less relevant to the user who wishes to identify specific information quickly. For example, the addition of a second, perhaps descriptive word to a single word significantly enhances the meaning, e.g. “chemistry teacher” conveys more information about the teacher than just “teacher” and hence chemistry teacher can be retained as a more specific and hence potentially more relevant topic than teacher. Nevertheless, some single word exceptions are retained. For example, topics that are proper nouns, for example the names of people, places or products, are identified by their use of a capital letter and included because these often refer to proprietary or personal information, e.g. trade names or the names of important people such as the CEO, which can be indicative of important topics for an executive or researcher to find. Words that are not included in a standard dictionary can also be retained. This is because any word not in a dictionary is likely to be highly specialised or unusual, and hence there is a high chance this will be related to this web site, regardless of the specific content of the web site.

The web site analysis also excludes those topics that are not related to at least one other topic in the reduced list, as illustrated in FIG. 11. To do this, the analysis involves determining a list of words related to each of a plurality of key topics identified in the website and determining whether each key topic appears in the list of related words for any of the other key topics in the website. Then any of the key topics where the key topic does not appear in the list of related words for any other of the key topics are discarded. A dictionary or thesaurus or other method can be used to determine related words. As an example, on the site about “teachers”, a topic of “transport” bears no obvious relation to any of the other, teacher-related key topics, and hence can be excluded, whereas a topic of “class” in the reduced list will be identified as related to “teacher” (and probably also to other topics in the reduced list) and hence will be included. Similarly, words which can be loosely related to “education”, although they do not appear to be related to “teacher” can also be included, building a list of key topics which gradually reduces in relevance as the reduced list is traversed but which largely excludes unrelated topics.

An advantage of testing for related key words is that the process can increase the accuracy of results by removing unrelated topics, while preventing the conventional need to have advance knowledge of the content of the site being analysed to select initial key words to which all others have to be related. This is because all potential topic words in the reduced list are tested for a relationship to every other word in the reduced topic list using a standard thesaurus, rather than tested for a relationship to key words which are selected through prior knowledge of the content of the site. Alternatively, a subset of the reduced topic list can be tested to reduce the processing required.

The search process is adapted to give preference to topics with large variance in position with respect to formatting elements such as bounding boxes (hidden or visible) on and in a page. This is because many words that are not true topics appear in the same place in many or all pages e.g. in a banner or button bar repeated at the same place on each page. These can appear erroneously in conventional searching, which relies on frequency of occurrence alone. However, a feature of real topics is that they are often spread amongst text, rather than at one specific place in the document. As a result, checking for the variance in position of topics with respect to the formatting elements, which generally surround banners and button bars, tends to exclude some of these statically-located elements from the reduced list.

Once the reduced list of key topics on all pages of the site is determined, the content of each page that has been previously logged is re-analysed, page-by-page to identify those pages that rank highest for topics in the final reduced list. At the same time, each page is also processed to generate a page-by-page topic list of key topics on each page. The reduced list is then used to generate all Main Views and the page-by-page topic list is used to generate all Subsequent Views. In order to provide a topic rank, the incidence of each topic is used to allocate a measure of importance to that topic. This can be done by counting the number of instances a particular topic is mentioned on the site as a whole. Preferably, the measure of importance is expressed as a percentage of the total number of words on the website as a whole or alternatively as a percentage of the sum of the instances of all of the key topic words.

When a measure of the importance of each topic is determined, this is used to construct the Main View 10 of the guide or map. Generally, topics that are of most importance are presented at the top of a key topic list, as shown in FIG. 1. In this way, the guide in which the invention is embodied provides a very simple and effective mechanism to enable the user to navigate around a web site. Ideally, the guide or map is presented automatically to a user when the web site is accessed, without the need for a user to initiate a keyword search. In order to ensure that the map is up-to-date, the web site should be analysed regularly.

In summary, the overall strategy for analysing the site is as follows: Identify an initial reduced list of single key words by counting the number of occurrences of every word in the site; comparing the number of occurrences of each word with the average frequency of each word in the language of the site; on the web site or over a large number of web sites, or in a target language or languages, and selecting those words having the highest frequency compared with the average. Once this is done, the reduced list is amended to include multi-word phrases by: locating each occurrence of words in the reduced list on the site and extracting and appending subsequent words on the site to form key phrases for each key word; counting the number of occurrences of each key phrase in the site, and selecting those phrases that have the highest frequency on site. Then, single words are excluded from the reduced list with the exception of proper nouns or words, words that are not in the dictionary or words that are related to other words in reduced list. The phrases are then ranked according to their incidence in the site and the highest-ranking phrases are selected and included in the final key topic list for the site as a whole. Subsequent to this, the content of each page is re-analysed page-by-page from previously logged information to identify those pages with the highest importance for each topic in the final reduced list. All other key topics in the reduced list on the page are also then logged in a page-by-page key topic list to be used to generate Subsequent Views later in the process. Once this is done, the Main and Subsequent Views of the guide can be generated.

The above technique for determining topic profiles can be applied to a plurality of different web sites, and these profiles can be used to identify a degree of similarity. Once measures of importance have been determined for each of the key topics on more than one site, the resulting topic profiles can be compared by selecting each website in turn, then selecting every other website in turn to form a series of {target website, candidate website} pairs. The topic profiles for each of these pairs can then be compared by selecting each topic in the target profile, comparing the measure of importance of this topic against the measure of importance of the same or similar topic(s) in the candidate website, if they exist. This is illustrated in FIG. 12. In the preferred embodiment, this can be done relatively simply, because the measure of importance is normalised as part of the profile building process described above, so that the measure of importance is generally expressed as a percentage or fraction of a pre-determined characteristic. An aggregate measure of importance can then be computed which is an aggregate of the comparison values across all topics common to both sites. As a variation on this, rather than using a topic profile generated as described previously, the target profile may be a manual profile that contains more than one topic and may contain a measure of importance of the topic to the target website as a whole.

In order to compare the topic profiles, the first and simplest method is to count the topics that are common to both profiles. A second, potentially more accurate method is shown in FIG. 13. This involves selecting a target profile 70 and a first candidate website profile 72. Then, preferably starting from the most important topic in the target profile, each topic in that profile that is common to the candidate profile is selected 74, and compared with the same or similar topic of the candidate site. In particular, the magnitude of a topic's measure of importance (e.g. topic word frequency) in both profiles is compared, as illustrated in FIG. 12. This provides a comparison value for the similarity of this topic in the profiles, across the two sites being compared. This is repeated for all key topics in the target profile 76. Deriving an aggregate comparison value then can be achieved by summing the magnitude of the comparison for all common topics across the two sites being compared. This process is then repeated for all candidate web-sites 78.

Once key topics are identified, the Main, Subsequent and Related Views for the guide can be generated. The steps for doing this are shown in FIGS. 14, 15 and 16. To do this, three page templates firstly have to be generated, one for the Main View, as shown in FIG. 1, one for the Subsequent Views, that is the pages shown in FIG. 2 and one for the Related Views, that is the pages shown in FIG. 3. These templates can take any desired form or layout or design.

Once the templates are provided, they can be used to generate the guide. As shown in FIG. 14, generating the Main View pages involves selecting a page template structure for FIG. 1, i.e. a Main View page layout (HTML code) 80. Then, preferably starting from the most important topic in the key topic list, each topic and rank is inserted as HTML code in the template 82. The page is then published to a results web site 84. This is repeated until all key topics have been inserted into templates 86. FIG. 15 shows the steps for generating Subsequent View pages. This may be done after generation of the Main View pages, and involves firstly selecting a page template structure for FIG. 2 page layout (HTML code) 88. Then preferably starting from the most important page for each topic, key topics from the page-by-page key topic list and corresponding ranks are inserted as HTML code in the template 90. The page is then published to the results web site 92. This is repeated until all pages for the key topic have been inserted into templates 94, and the whole process is then repeated for all other key topics in the reduced list 96. Finally, the Related View pages, as illustrated in FIG. 3, are then generated by selecting a suitable page template structure, as shown in FIG. 16. Then, preferably starting from the most similar website to the target profile in the related website list, each website and similarity is inserted as HTML code in the template. The page is then published to a results web site. This is repeated until all related websites have been inserted into templates.

Once the guide is created, it can be incorporated into the relevant web site or hosted as a separate, linked web site, in such a manner that it is presented to a user when the site is selected or when the user wishes to browse the site. Techniques for implementing this are of course well known in the art.

A skilled person will appreciate that variations of the disclosed arrangements are possible without departing from the invention. For example, a home page or company financial information may be presented in the Main View together with the key topics list of FIG. 1. This would typically show a preview of the site home page, thereby giving a quick visual indication that the user is looking at the correct site. As a second example, the Subsequent View may show a page preview of the page, which the topic list refers to, to allow the user to quickly evaluate whether the page warrants further investigation e.g. clicking to the live page. As yet another alternative, although the invention is described primarily with reference to web sites and the internet, it will be appreciated that the techniques described herein could be used to provide a mechanism for navigating round any collection of text based electronic documents. For example, the system could be used in or applied to a Windows based system so as to provide a topic profile of all text-based documents stored on a local PC regardless of the format. Accordingly, the above description of a specific embodiment is made by way of example only and not for the purposes of limitation. It will be clear to the skilled person that minor modifications may be made without significant changes to the operation described.

1-49. (canceled)

50. A method for identifying a measure of similarity between the activities of a plurality of parties, for example companies, using groups of information/text associated with, and representative of those parties on the world wide web or in other information stores, the method comprising deriving a content profile for the information group of each party, and comparing the profiles to identify a degree of similarity.

51. A method as claimed in claim 50 wherein deriving the content profile of a group involves analyzing every group of text to identify key topics; allocating a measure of importance to identified key topics, and using that measure and the identified topics to generate the content profile.

52. A method as claimed in claim 50 wherein the step of analyzing is based on a word frequency analysis and comprises selecting topics which have a higher than average frequency of occurrence in the group than in the native language of the group.

53. A method as claimed in claim 51 wherein the step of analyzing involves discarding topics that are not related to important key words.

54. A method as claimed in claim 51 comprising:
determining a list of words related to each of a plurality of key topics identified in the group; and
determining whether each key topic appears in the list of related words for any of the other key topics in the group and discarding any of the key topics where the key topics does not appear in the list of related words for any other of the key topics.

55. A method as claimed in claim 51 wherein the step of comparing comprises counting the number of topics common to the profiles of each party.

56. A method as claimed in claim 51 wherein comparing the profiles involves comparing the measures of importance for each key topic.

57. A method as claimed in claim 51 wherein the step of comparing involves calculating an aggregated comparison across all topics common between the profiles being compared.

58. A method for measuring the similarity of groups of electronic text comprising determining a content profile for each of a plurality of groups of text based electronic documents and comparing the profiles to identify a degree of similarity.

59. A system for identifying a measure of similarity between the activities of a plurality of parties, for example companies, using groups of text associated with, and representative of those parties on the world wide web or in other information stores, the system being operable to derive a content profile for the information group of each party, and compare the profiles to identify a degree of similarity.

60. A system as claimed in claim 59 wherein deriving the content profile of a group involves analyzing every group of text to identify key topics; allocating a measure of importance to identified key topics, and using that measure and the identified topics to generate the content profile.

61. A system as claimed in claim 59 that is operable to analyze group text based on a word frequency analysis which comprises identifying key topics by selecting topics which have a higher than average frequency in the group than in the native language of the group as a whole.

62. A system as claimed in claim 60 that is operable to discard topics that are not related to important key words.

63. A system as claimed in claim 60 that is operable to determine a list of words related to each of a plurality of key topics identified in the group; determine whether each key topic appears in the list of related words for any of the other key topics in the group and discard any of the key topics where the key topics does not appear in the list of related words for any other of the key topics.

64. A method for profiling a group or collection of electronic text, the method comprising analyzing every group of text in the collection to identify key topics; allocating a measure of importance to identified key topics, and using that measure to generate a topic profile that includes a plurality of topic identifiers and an indication of the importance of each of the topics identified to the collection as a whole or in part.

65. A method as claimed in claim 64 wherein the group of electronic document text comprises pages of a web site.

66. A method as claimed in claim 64 further involving downloading each page of the site in order to do the step of analyzing.

67. A method as claimed in claim 64 wherein the step of analyzing is based on a word frequency analysis which comprises identifying key topics by selecting topics which have a higher than average frequency in the group than in the native language of the group as a whole.

68. A method as claimed in claim 64 wherein the step of analyzing the documents involves determining a list of words related to each of a plurality of key topics identified in the group; determining whether each key topic appears in the list of related words for any of the other key topics in the group and discarding any of the key topics where the key topics does not appear in the list of related words for any other of the key topics.

69. A system for profiling a group or collection of text, the system being operable to:
analyze every document in the group of text in the collection to identify key topics; and
allocate a measure of importance to identified key topics, and use that measure to generate a topic profile that includes a plurality of topic identifiers and an indication of the importance of each of the topics identified to the group as a whole.

70. A system as claimed in claim 69 comprising: means for determining a list of words related to each of a plurality of key topics identified in the group; means for determining whether each key topic appears in the list of related words for any of the other key topics in the group and means for discarding any of the key topics where the key topics does not appear in the list of related words for any other of the key topics.

71. A system for allowing navigation within a group of electronic documents, such as a subset of the world-wide web, the said system capable of:
automatically presenting on a screen or display a plurality of topic identifiers, together with an indication of the relative importance of the topics identified, each topic being user selectable, topics being presented in a pre-determined order, thereby to provide an indication of the importance of the topics to the group as a whole or in part; and
receiving a user selection of a given topic and providing access to information on the selected topic in response to the user selection.

72. A system as claimed in claim 71, wherein said system is further capable of presenting related group identifiers for identifying one or more related groups of electronic documents, such as internet or intranet sites, together with an indication or measure of a similarity between a key topic profile of the first group and each related group.
